(19) United States
(12) Patent Application Publication
(10) Pub. No.: US 2026/0135489 A1
(43) Pub. Date: May 14, 2026

(54) RESONANT POWER CONVERSION CIRCUIT AND CONTROL METHOD THEREOF THAT SIMULTANEOUSLY CONTROLS RESONANT VOLTAGE AND OUTPUT VOLTAGE

(71) Applicant: Richtek Technology Corporation, Zhubei City (TW)

(72) Inventors: Ta-Yung YANG, Taoyuan City (TW); Tzu-Chen LIN, Zhubei City (TW); Kuo-Chi LIU, Hsinchu City (TW); Kun-Yu LIN, Zhubei City (TW)

(21) Appl. No.: 19/326,806

(22) Filed: Sep. 12, 2025

Related U.S. Application Data
(60) Provisional application No. 63/719,149, filed on Nov. 12, 2024.

(30) Foreign Application Priority Data
Jul. 21, 2025 (TW) 114127521

(51) Int. Cl. H02M 3/335; H02M 3/00

(52) U.S. Cl. CPC H02M 3/3353; H02M 3/01

(57) ABSTRACT

A power conversion circuit for converting an input voltage to an output voltage includes a resonant capacitor, a transformer, a high-side transistor, a low-side transistor, and a control circuit. The resonant capacitor is coupled between a resonant node and a ground, and a resonant voltage is generated at the resonant node. The transformer includes a primary coil coupled between a switch node and a resonant node and a secondary coil. The high-side transistor provides the input voltage to the switch node, and the low-side transistor couples the switch node to the ground. When the high-side transistor and the low-side transistor are both turned off, the control circuit first determines that the resonant voltage is less than a predetermined threshold and then drives the high-side transistor and the low-side transistor.

### CROSS REFERENCE TO RELATED APPLICATIONS

This application claims the benefit of U.S. Provisional Application No. 63/719,149, filed on Nov. 12, 2024, the entirety of which is incorporated by reference herein.

This application claims priority of Taiwan Patent Application No. 114127521, filed on Jul. 21, 2025, the entirety of which is incorporated by reference herein.

### BACKGROUND OF THE INVENTION

### Field of the Invention

The disclosure is generally related to a power conversion circuit and a control method thereof, and more particularly it is related to a resonant power conversion circuit and a control method thereof that simultaneously controls the resonant voltage and the output voltage.

### Description of the Related Art

With the continuous advancements being made in portable electronic devices, the development of power conversion circuits, like most power products, has seen a trend toward higher efficiency, higher power density, better reliability, and lower costs. Since resonant power conversion circuits (which include LLC resonant power conversion circuits, flyback power conversion circuits, and others) are high-efficiency and high-power density power conversion circuits, resonant power conversion circuits are gradually becoming the preferred choice for power conversion circuits used in portable electronic devices.

However, current resonant power conversion circuits still have many defects, so it is necessary to further optimize resonant power conversion circuits.

### BRIEF SUMMARY OF THE INVENTION

The present invention provides a power conversion circuit and a control method thereof, which determines whether to discharge the resonant capacitor and the output capacitor after the high-side transistor and the low-side transistor both are turned off, so as to avoid generating surges in the secondary coil of the transformer to reduce the life of components.

In an embodiment, a power conversion circuit for converting an input voltage to an output voltage is provided, which comprises a resonant capacitor, a transformer, a high-side transistor, a low-side transistor, and a control circuit. The resonant capacitor is coupled between a resonant node and a ground, wherein a resonant voltage is generated at the resonant node. The transformer comprises a primary coil and a secondary coil, wherein the primary coil is coupled between a switch node and the resonant node. The high-side transistor provides the input voltage to the switch node based on a high-side driving signal. The low-side transistor couples the switch node to the ground based on a low-side driving signal. The control circuit generates the high-side driving signal and the low-side driving signal based on the output voltage and the resonant voltage. When the high-side transistor and the low-side transistor are both turned off, the control circuit first determines whether the resonant voltage is lower than a predetermined threshold, and then drives the high-side transistor and the low-side transistor.

According to an embodiment of the present invention, a discharge rate of the output voltage is faster than a discharge rate of the resonant capacitor.

According to an embodiment of the present invention, the power conversion circuit further comprises a first discharge circuit and a second discharge circuit. The first discharge circuit discharges the resonant capacitor. The second discharge circuit discharges the output voltage.

According to an embodiment of the present invention, the first discharge circuit further comprises a detection resistor and a discharge resistor. The detection resistor is coupled to the resonant node. The discharge resistor is coupled between the detection resistor and the ground. The control circuit adjusts the resistance value of the discharge resistor to adjust a discharge current for discharging the resonant capacitor.

According to an embodiment of the present invention, the resonant voltage is divided by the detection resistor and the discharge resistor to generate a control voltage. The control circuit further comprises an analog-to-digital converter. The analog-to-digital converter is configured to convert the control voltage into a digital code. The control circuit determines whether the resonant voltage is lower than the predetermined threshold based on the digital code. When the control circuit determines that the resonant voltage is lower than the predetermined threshold, the control circuit generates the high-side driving signal and the low-side driving signal.

According to an embodiment of the present invention, the power conversion circuit further comprises a rectification circuit and a secondary control circuit. The rectification circuit converts energy of the secondary coil into the output voltage based on a gate signal. The secondary control circuit generates the gate signal. When the output voltage exceeds a first voltage threshold or does not exceed a second voltage threshold, the secondary control circuit enables a discharge signal.

According to an embodiment of the present invention, the secondary control circuit further comprises a first comparator, a second comparator, and an OR gate. The first comparator is configured to compare the output voltage with the first voltage threshold to generate a first comparison signal. The second comparator is configured to compare the second voltage threshold with the output voltage to generate a second comparison signal. The OR gate performs a logic OR operation on the first comparison signal and the second comparison signal to generate the discharge signal.

According to an embodiment of the present invention, when the output voltage exceeds the first voltage threshold, the first comparator enables the first comparison signal. When the output voltage does not exceed the first voltage threshold, the first comparator disables the first comparison signal. When the output voltage does not exceed the second voltage threshold, the second comparator enables the second comparison signal. When the output voltage exceeds the second voltage threshold, the second comparator disables the second comparison signal. When the first comparison signal is enabled or the second comparison signal is enabled, the OR gate enables the discharge signal.

According to an embodiment of the present invention, the second discharge circuit comprises an output discharge resistor and a discharge switch. The output discharge resistor is coupled to the output voltage. The discharge switch couples the output discharge resistor to the ground based on the discharge signal being enabled, so that the output discharge resistor discharges the output voltage.

According to another embodiment of the present invention, the second discharge circuit comprises an output discharge current source and a discharge switch. The output discharge current source generates a first current and coupled to the output voltage. The discharge switch couples the output discharge current source to the ground based on the discharge signal being enabled, so that the output voltage is discharged with the first current.

According to an embodiment of the present invention, the power conversion circuit further comprises an opto-coupler. The opto-coupler generates a feedback voltage based on a feedback current. The secondary control circuit generates the feedback current based on the output voltage. The control circuit generates the high-side driving signal and the low-side driving signal based on the feedback voltage and the resonant voltage.

According to an embodiment of the present invention, the transformer further comprises an auxiliary coil. The auxiliary coil generates an auxiliary coil voltage. The power conversion circuit further comprises a first voltage divider circuit. The first voltage divider circuit multiplies the auxiliary coil voltage by a first voltage-dividing ratio to generate a demagnetization voltage. The control circuit generates the predetermined threshold based on the demagnetization voltage.

According to an embodiment of the present invention, the power conversion circuit is a resonant flyback power conversion circuit.

In another embodiment, a control method for controlling a power conversion circuit to convert an input voltage to an output voltage is provided. The power conversion circuit comprises a resonant capacitor coupled between a resonant node and a ground, a transformer comprising a primary coil and a secondary coil, a high-side transistor providing the input voltage to a switching node, and a low-side transistor coupling the switch node to the ground. The primary coil is coupled between the switch node and the resonant node. The control method comprises the following steps. The high-side transistor and the low-side transistor are simultaneously turned off. After the step of simultaneously turning off the high-side transistor and the low-side transistor, it is determined whether a resonant voltage at the resonant node is lower than a predetermined threshold. When it is determined that the resonant voltage is lower than the predetermined threshold, the high-side transistor and the low-side transistor are driven to generate the output voltage.

According to an embodiment of the present invention, the control method further comprises the following steps. It is determined whether the output voltage needs to be discharged. When it is determined that the output voltage needs to be discharged, the output voltage is discharged. When it is determined that the output voltage does not need to be discharged, the output voltage is not discharged.

According to an embodiment of the present invention, the step of determining whether the output voltage needs to be discharged further comprises the following steps. It is determined whether the output voltage exceeds a first voltage threshold or does not exceed a second voltage threshold. When it is determined that the output voltage exceeds the first voltage threshold or does not exceed the second voltage threshold, the output voltage is discharged. When it is determined that the output voltage does not exceed the first voltage threshold and exceeds the second voltage threshold, not discharging the output voltage is not discharged.

According to an embodiment of the present invention, the step of determining whether the output voltage needs to be discharged is performed simultaneously with the step of determining whether the resonant voltage at the resonant node is lower than the predetermined threshold.

According to another embodiment of the present invention, the step of determining whether the output voltage needs to be discharged is performed after the step of simultaneously turning off the high-side transistor and the low-side transistor, and before the step of determining whether the resonant voltage at the resonant node is lower than the predetermined threshold.

According to an embodiment of the present invention, the step of discharging the output voltage further comprises the following steps. An output discharge resistor is coupled to the output voltage, so that the output voltage is discharged through the output discharge resistor.

According to an embodiment of the present invention, the step of discharging the output voltage further comprises the following steps. A first current is sunk from the output voltage, so that the output voltage is discharged with the first current.

According to an embodiment of the present invention, a discharge rate of the output voltage is faster than a discharge rate of the resonant capacitor.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of a power conversion circuit in accordance with an embodiment of the present invention;

FIG. 2 is a waveform diagram of a power conversion circuit in accordance with an embodiment of the present invention;

FIG. 3 is a block diagram of a power conversion circuit in accordance with another embodiment of the present invention;

FIG. 4 is a block diagram of a signal generation circuit in accordance with an embodiment of the present invention;

FIG. 5 is a block diagram of a power conversion circuit in accordance with yet another embodiment of the present invention;

FIG. 6 is a block diagram of a detection circuit in accordance with an embodiment of the present invention; and

FIG. 7 is a flow chart of a control method for a power conversion circuit in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

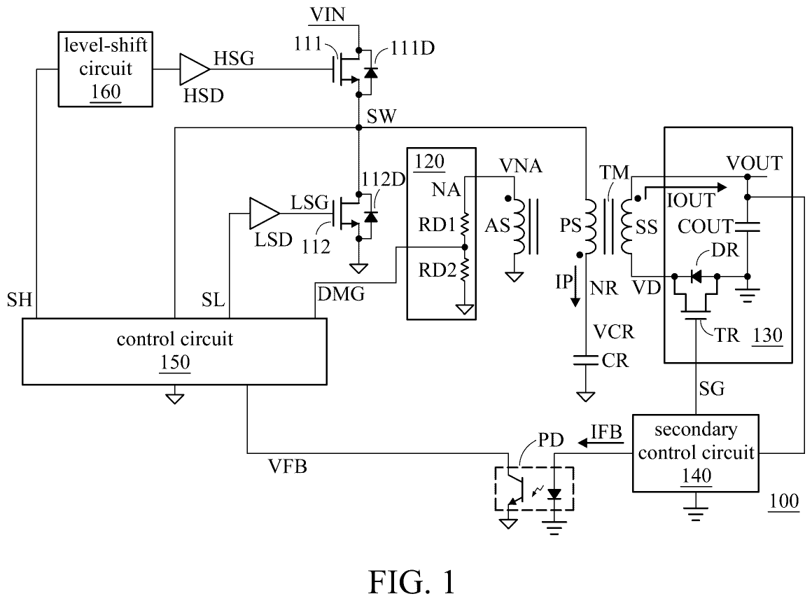

FIG. 1 is a block diagram of a power conversion circuit in accordance with an embodiment of the present invention. As shown in FIG. 1, the power conversion circuit 100 includes a high-side transistor 111, a low-side transistor 112, a resonant capacitor CR, a transformer TM, a first voltage-dividing circuit 120, a rectification circuit 130, a secondary control circuit 140, an opto-coupler PD, a control circuit 150, a level-shift circuit 160, a high-side driving circuit HSD, and a low-side driving circuit LSD.

The high-side transistor 111 provides an input voltage VIN to the switch node SW based on the high-side gate driving signal HSG. According to an embodiment of the present invention, the high-side transistor 111 includes a high-side parasitic diode 111D, where the high-side parasitic diode 111D is coupled between the switch node SW and the input voltage VIN. The low-side transistor 112 couples the switch node SW to the ground based on the low-side gate driving signal LSG. According to an embodiment of the present invention, the low-side transistor 112 includes a low-side parasitic diode 112D, where the low-side parasitic diode 112D is coupled between the switch node SW and the ground.

The resonant capacitor CR is coupled between the resonant node NR and the ground, and a resonant voltage VCR is generated across the resonant capacitor CR. The transformer TM includes a primary coil PS, a secondary coil SS, and an auxiliary coil AS. The primary coil PS is coupled between the switch node SW and the resonant node NR. The auxiliary coil AS is coupled between the auxiliary node NA and the ground, and an auxiliary coil voltage VNA is generated at the auxiliary node NA. The output current IOUT generated by the secondary coil SS generates an output voltage VOUT through the rectification circuit 130.

According to some embodiments of the present invention, the primary coil PS and the resonant capacitor CR are connected in series between the switch node SW and the ground. In other words, the resonant capacitor CR may be coupled between the switch node SW and the resonant node NR, and the primary coil PS may be coupled between the resonant node NR and the ground. The first voltage-dividing circuit 120 includes a first voltage-dividing resistor RD1 and a second voltage-dividing resistor RD2, which are configured to generate a demagnetization voltage DMG using the auxiliary coil voltage VNA.

The rectification circuit 130 is configured to convert the output current IOUT generated by the secondary coil SS into an output voltage VOUT, and includes a rectification transistor TR and an output capacitor COUT. According to some embodiments of the present invention, the rectification transistor TR further includes a rectification parasitic diode DR. The rectification transistor TR is turned on based on the gate signal SG, so that the output current IOUT output by the secondary coil SS charges the output capacitor COUT to generate the output voltage VOUT. When the rectification transistor TR is turned off, the voltage from the drain terminal to the source terminal of the rectification transistor TR is the drain voltage VD.

The secondary control circuit 140 generates a feedback current IFB based on the output voltage VOUT, where the feedback current IFB generates a feedback voltage VFB through the opto-coupler PD. The secondary control circuit 140 further generates the gate signal SG for converting the output current IOUT generated by the secondary coil SS into the output voltage VOUT.

The control circuit 150 generates a high-side driving signal SH and a low-side driving signal SL based on the feedback voltage VFB. The level-shift circuit 160 is configured to shift the voltage level of the high-side driving signal SH to the input voltage VIN, and the high-side drive circuit HSD generates the high-side gate driving signal HSG based on the shifted signal to drive the high-side transistor 111. The low-side driving circuit LSD generates a low-side gate driving signal LSG based on the low-side driving signal SL to drive the low-side transistor 112.

According to some embodiments of the present invention, the control circuit 150 further generates a high-side driving signal SH and a low-side driving signal SL according to the voltage of the switch node SW, so that both the high-side transistor 111 and the low-side transistor 112 achieve zero-voltage switching (ZVS), which improves the conversion efficiency of the power conversion circuit 100. According to some embodiments of the present invention, the power conversion circuit 100 may be a resonant power conversion circuit. According to some embodiments of the present invention, the power conversion circuit 100 may be a resonant flyback power conversion circuit. According to some embodiments of the present invention, the power conversion circuit 100 may be an asymmetrical half-bridge flyback power conversion circuit.

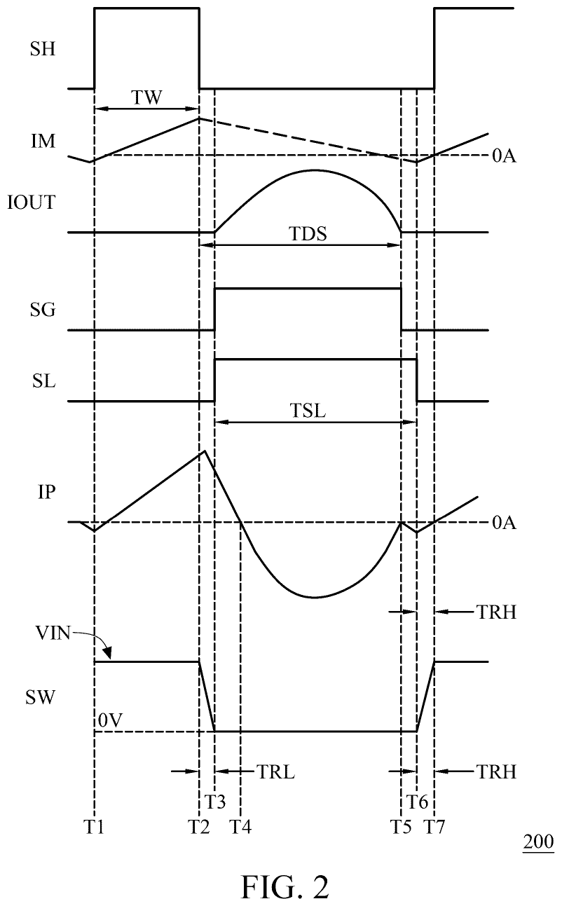

FIG. 2 is a waveform diagram of a power conversion circuit in accordance with an embodiment of the present invention. The following description of the waveform diagram 200 will be described in detail in conjunction with the power conversion circuit 100 of FIG. 1. From the first time point T1 to the second time point T2, the high-side transistor 111 is turned on based on the high-side driving signal SH (i.e., the high-side driving signal SH is at the high logic level). The high-side conduction time TW is the conduction time of the high-side transistor 111. During the high-side conduction time TW, the transformer TM is magnetized to generate a magnetizing current IM. As the conduction time TW increases, the magnetizing current IM of the transformer TM, the primary current IP flowing through the primary coil PS, and the resonant voltage VCR all increase accordingly. In other words, the high-side conduction time TW is the magnetizing time of the transformer TM.

When the high-side transistor 111 is turned off (i.e., the high-side driving signal SH is at the low logic level), the transformer 10 is demagnetizing. During the demagnetization period TDS, the transformer 10 generates an output current IOUT, and the conduction time of the low-side transistor 112 (i.e., the low-side driving signal SL is at the high logic level) corresponds to the demagnetization period TDS. According to some embodiments of the present invention, the low-side conduction time TSL of the low-side driving signal SL is equal to or greater than the demagnetization period TDS. During the demagnetization period TDS, the voltage across the primary coil PS is equal to the resonant voltage VCR, and the relationship between the resonant voltage VCR and the output voltage VOUT is as shown in Eq. 1.

$$\begin{matrix}V CR = n \times V OUT \\ n = \frac{N P}{N S}\end{matrix} \qquad ( Eq . 1 )$$

NP is the number of turns in the primary coil PS, NS is the number of turns in the secondary coil SS, and the turn ration is the number of turns in the primary coil PS divided by the number of turns in the secondary coil SS.

The demagnetization period TDS is shown in Eq. 2.

$$T D S = \frac{( V IN - V CR ) \times TW}{n \times V OUT} \qquad ( Eq . 2 )$$

When the high-side transistor 111 is turned on, (VIN−VCR) is the voltage configured to magnetize the transformer TM.

At the second time point T2, the high-side driving signal SH is converted to the low logic level to turn off the high-side transistor 111. At the third time point T3, the low-side driving signal SL is converted to the high logic level to turn on the low-side transistor 112. According to some embodiments of the present invention, the first dead time TRL from the second time point T2 to the third time point T3 is the dead time from the high-side transistor 111 being turned off to the low-side transistor 112 being turned on.

According to some embodiments of the present invention, during the first dead time TRL, the circulating current generated by the primary coil PS turns on the low-side parasitic diode 112D, and pulls down the voltage of the switch node SW, so that the low-side transistor 112 reaches zero-voltage switching. At the third time point T3, the voltage across the primary coil PS is the resonant voltage VCR of the resonant capacitor CR.

From the third time point T3 to the fourth time point T4, the high-side transistor 111 is turned off, and the low-side transistor 112 is turned on under zero-voltage switching. The rectification transistor TR is turned on, so that the output current IOUT flows through the rectification transistor TR to generate an output voltage VOUT, where the output voltage VOUT is equal to the resonant voltage VCR divided by the turn ratio n, as shown in Eq. 1. In addition, the primary current IP is still positive and flows into the resonant capacitor CR.

According to some embodiments of the present invention, the leakage inductance of the primary coil PS and the resonant capacitor CR form a resonant tank. The output current IOUT is in the form of a sine wave, and the frequency is determined by the resonant frequency of the resonant circuit. The primary current IP is the reflection of the magnetizing current IM plus the output current IOUT.

From the fourth time point T4 to the fifth time point T5, the high-side transistor 111 is continuously turned off and the low-side transistor 112 is continuously turned on. The energy of the transformer TM is continuously transferred to the secondary winding SS, and the energy at this time is provided by the resonant capacitor CR. In addition, since the low-side transistor 112 is continuously turned on, the energy of the resonant capacitor CR is configured to bring the magnetizing current IM to a negative value.

At the fifth time point T5, the rectification transistor TR is not turned on based on the gate signal SG, thereby ending the demagnetization period TDS. From the fifth time point T5 to the sixth time point T6, the resonant capacitor CR continues to reversely magnetize the primary winding PS, so that the primary current IP remains negative until the low-side transistor 112 is turned off.

From the sixth time point T6 to the seventh time point T7, the high-side transistor 111 and the low-side transistor 112 are both turned off, and the primary current IP induced as a negative current from the fifth time point T5 to the sixth time point T6 turns on the high-side parasitic diode 111D, so that the voltage of the switch node SW rises to the input voltage VIN. According to some embodiments of the present invention, the second dead time TRH from the sixth time point T6 to the seventh time point T7 is the dead time from the low-side transistor 112 being turned off to the high-side transistor 111 being turned on.

At the seventh time point T7, the high-side driving signal SH is at the high logic level. Since the voltage of the switch node SW rises to the input voltage VIN, the high-side transistor 111 is able to be turned under zero-voltage switching.

Since the resonant capacitor CR is connected in parallel with the primary coil PS when the transformer TM is demagnetized, the resonant voltage VCR is the output voltage VOUT multiplied by the turn ratio of the transformer TM. When the voltage difference between the resonant voltage VCR and the output voltage VOUT multiplied by the turn ratio is too large, the drain voltage VD would generate a very high voltage spike, reducing the reliability of the rectification transistor TR and even damaging the rectification transistor TR.

Under normal operation, the resonant voltage VCR would be very close to the voltage value of the output voltage VOUT multiplied by the turn ratio of the transformer TM, thereby avoiding the generation of voltage spike at the drain voltage VD. However, when the power conversion circuit 100 is turned on and off quickly and frequently, the output voltage VOUT would be discharged through the load, making the difference between the resonant voltage VCR and the output voltage VOUT multiplied by the turn ratio of the transformer TM significant, thereby causing a voltage spike at the drain voltage VD. In order to protect the rectification transistor TR from being damaged by voltage spike, it is necessary to optimize the power conversion circuit 100.

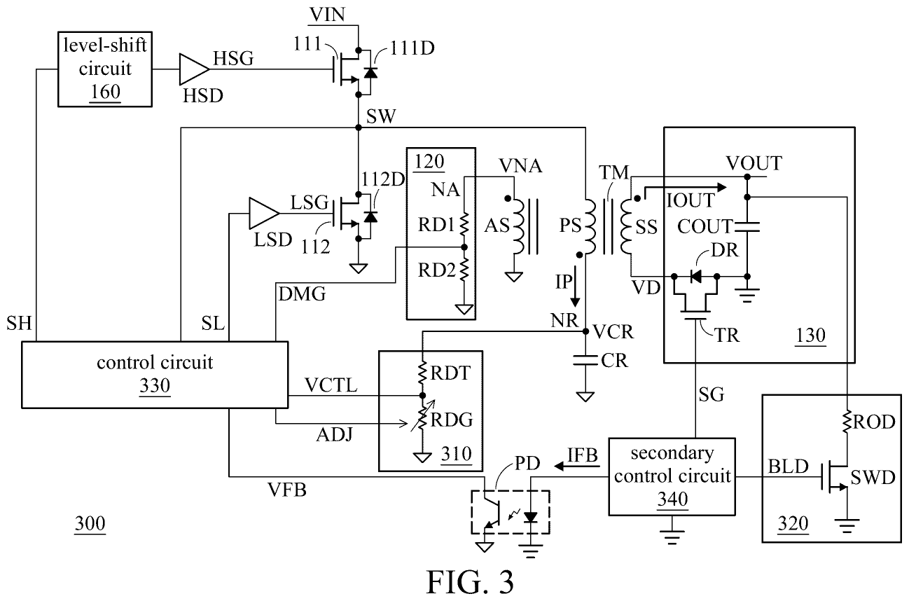

FIG. 3 is a block diagram of a power conversion circuit in accordance with another embodiment of the present invention. Comparing the power conversion circuit 300 of FIG. 3 with the power conversion circuit 100 of FIG. 1, the power conversion circuit 300 further includes a first discharge circuit 310 and a second discharge circuit 320, the control circuit 150 of the power conversion circuit 100 is replaced by a control circuit 330, and the secondary control circuit 140 is replaced by a secondary control circuit 340.

The first discharge circuit 310 is configured to discharge the resonant capacitor CR and to divide the resonant voltage VCR to generate a control voltage VCTL. The first discharge circuit 310 includes a detection resistor RDT and a discharge resistor RDG. The detection resistor RDT is coupled between the resonant node NCR and the control voltage VCTL, and the discharge resistor RDG is coupled between the control voltage VCTL and ground.

According to one embodiment of the present invention, the control voltage VCTL is equal to the resonant voltage VCR multiplied by the voltage-dividing ratio of the first discharge circuit 310. The voltage-dividing ratio of the first discharge circuit 310 is the resistance value of the discharge resistor RDG divided by the sum of the resistance values of the discharge resistor RDG and the detection resistor RDT. According to some embodiments of the present invention, the control circuit 330 may use the adjustment signal ADJ to adjust the resistance value of the discharge resistor RDG, thereby adjusting the discharge current discharged from the resonant capacitor CR.

According to one embodiment of the present invention, when both the high-side transistor 111 and the low-side transistor 112 are off, the control circuit 330 may detect the control voltage VCTL to determine whether the resonant voltage VCR is lower than a predetermined threshold. When the resonant voltage VCR is lower than the predetermined threshold, the control circuit 330 begins driving the high-side transistor 111 and the low-side transistor 112.

The relationship between the resonant voltage VCR and the output voltage VOUT shown in Eq. 1 that may be rewritten to Eq. 3.

$$\begin{matrix}V OUT = \frac{1}{n} \times V CR \\ n = \frac{N P}{N S}\end{matrix} \qquad ( Eq . 3 )$$

The relationship between the auxiliary coil voltage VNA and the output voltage VOUT is shown in Eq. 4.

$$\begin{matrix}V NA = m \times V OUT \\ m = \frac{N A S}{N S}\end{matrix} \qquad ( Eq . 4 )$$

NAS is the number of turns in the auxiliary coil AS, NS is the number of turns in the secondary coil SS, and the turns ratio m is the number of turns in the auxiliary coil AS divided by the number of turns in the secondary coil SS.

The relationship between the demagnetization voltage DMG and the auxiliary coil voltage VNA is as shown in Eq. 5, where d1 is the voltage-dividing ratio of the first voltage-dividing circuit 120. In other words, d1 is equal to the resistance value of the second voltage-dividing resistor RD2 divided by the sum of the resistance value of the first voltage-dividing resistor RD1 and the resistance value of the second voltage-dividing resistor RD2.

$$\begin{matrix}DMG = d 1 \times V NA \\ d 1 = \frac{R D 2}{RD 1 + RD 2}\end{matrix} \qquad ( Eq . 5 )$$

The relationship between the control voltage VCTL and the resonant voltage VCR is as shown in Eq. 6, where d2 is the resistance value of the discharge resistor RDG divided by the sum of the resistance value of the discharge resistor RDG and the resistance value of the detection resistor RDT.

$$\begin{matrix}V CTL = d 2 \times V CR \\ d 2 = \frac{R D G}{R D G + R D T}\end{matrix} \qquad ( Eq . 6 )$$

Combining Eq. 3, Eq. 4, Eq. 5 and Eq. 6, the relationship between the demagnetization voltage DMG and the control voltage VCTL is shown in Eq. 7.

$$D M G = d 1 \times m \times \frac{1}{n} \times \frac{1}{d 2} \times V CTL \qquad ( Eq . 7 )$$

According to some embodiments of the present invention, to facilitate determination, the product of d1, m, 1/n, and 1/d2 can be adjusted to 1, so that the demagnetization voltage DMG equals the control voltage VCTL when the output voltage VOUT is stable. In other words, when the product of d1, m, 1/n, and 1/d2, equals 1 and the output voltage VOUT of the power conversion circuit 300 is stable, the control voltage VCTL approaches the demagnetization voltage DMG. Therefore, the control circuit 330 determines whether to discharge the resonant capacitor CR based on the relationship between the control voltage VCTL and the demagnetization voltage DMG.

According to an embodiment of the present invention, when the control circuit 330 determines that the control voltage VCTL exceeds the first threshold voltage and the first threshold voltage exceeds the demagnetization voltage DMG, it indicates that the resonant voltage VCR is too high. The control circuit 330 then determines that the resonant capacitor CR needs to be discharged. The control circuit 330 adjusts the discharge current of the resonant capacitor CR by adjusting the resistance value of the discharge resistor RDG to prevent a surge occurred in the drain voltage VD that could burn out the rectification transistor TR.

According to another embodiment of the present invention, when the control circuit 330 determines that the control voltage VCTL exceeds the second threshold voltage and the second threshold voltage is lower than the demagnetization voltage DMG, the control circuit 330 determines that the resonant capacitor CR needs to be discharged. Therefore, the power conversion circuit 300 discharges the resonant capacitor CR during startup to prevent a surge occurred in the drain voltage VD during startup that could burn out the rectification transistor TR.

The second discharge circuit 320 is configured to discharge the output voltage VOUT. The second discharge circuit 320 includes an output discharge resistor ROD and a discharge switch SWD. The output discharge resistor ROD is coupled to the output voltage VOUT. The discharge switch SWD, couples the output discharge resistor ROD to ground based on a discharge signal BLD being enabled, allowing the output discharge resistor ROD to discharge the output voltage VOUT. The secondary control circuit 340 enables the discharge signal BLD based on the state of the output voltage VOUT.

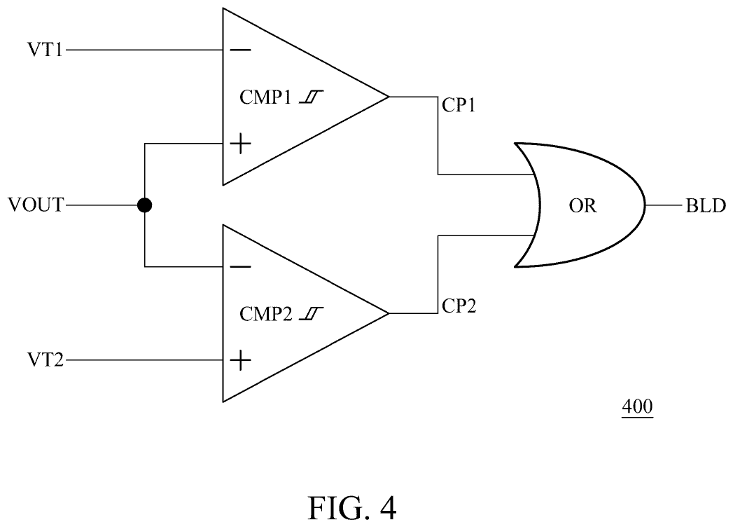

FIG. 4 is a block diagram of a signal generation circuit in accordance with an embodiment of the present invention. According to some embodiments of the present invention, the secondary control circuit 340 of FIG. 3 includes a signal generation circuit 400. As shown in FIG. 4, the signal generation circuit 400 includes a first comparator CMP1, a second comparator CMP2, and an OR gate OR. The first comparator CMP1 compares the output voltage VOUT with a first voltage threshold VT1 to generate a first comparison signal CP1.

According to an embodiment of the present invention, when the output voltage VOUT exceeds the first voltage threshold VT1, the first comparator CMP1 enables the first comparison signal CP1. According to another embodiment of the present invention, when the output voltage VOUT does not exceed the first voltage threshold VT1, the first comparator CMP1 disables the first comparison signal CP1.

The second comparator CMP2 compares the second voltage threshold VT2 with the output voltage VOUT to generate a second comparison signal CP2. According to an embodiment of the present invention, the second comparator CMP2 enables the second comparison signal CP2 when the output voltage VOUT does not exceed the second voltage threshold VT2. According to another embodiment of the present invention, the second comparator CMP2 disables the second comparison signal CP2 when the output voltage VOUT exceeds the second voltage threshold VT2.

The OR gate OR performs a logical OR operation on the first comparison signal CP1 and the second comparison signal CP2 to generate a discharge signal BLD. In other words, when the output voltage VOUT exceeds the first voltage threshold VT1 or does not exceed the second voltage threshold VT2, the discharge signal BLD is enabled, causing the output voltage VOUT in FIG. 3 to be discharged through the output discharge resistor ROD. According to an embodiment of the invention, the first voltage threshold VT1 is an over-voltage threshold, the second voltage threshold VT2 is an under-voltage threshold, and the first voltage threshold VT1 exceeds the second voltage threshold VT2. According to some embodiments of the present invention, the discharge rate of the output voltage VOUT is faster than the discharge rate of the resonant capacitor CR. Since the drain voltage VD is equal to the sum of the output voltage VOUT and the voltage across the secondary coil SS, and the drain voltage VD can also be expressed as shown in Eq. 8, the faster discharge rate of the output voltage VOUT helps to quickly reduce the drain voltage VD, thereby preventing the rectification transistor TR from burning out.

$$V D = V OUT + ( V I N - V CR ) \times \frac{N S}{N P} \qquad ( Eq . 8 )$$

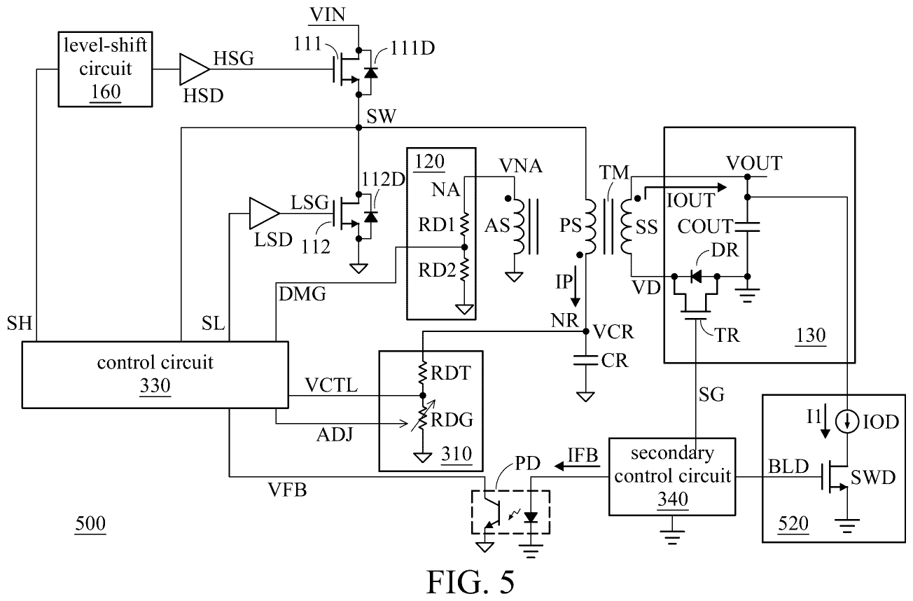

FIG. 5 is a block diagram of a power conversion circuit in accordance with yet another embodiment of the present invention. Comparing the power conversion circuit 500 in FIG. 5 with the power conversion circuit 300 in FIG. 3, the second discharge circuit 320 of the power conversion circuit 300 is replaced by a second discharge circuit 520. The second discharge circuit 520 includes an output discharge current source IOD and a discharge switch SWD.

The output discharge current source IOD is coupled to the output voltage VOUT and generates a first current I1. The discharge switch SWD couples the output discharge current source IOD to ground based on a discharge signal BLD being enabled, causing the output voltage VOUT to discharge with the first current I1. According to some embodiments of the present invention, the discharge rate of the output voltage VOUT is faster than the discharge rate of the resonant voltage VCR.

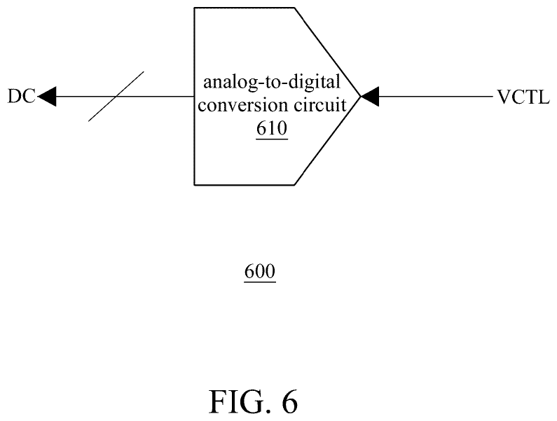

FIG. 6 is a block diagram of a detection circuit in accordance with an embodiment of the present invention. According to some embodiments of the present invention, the control circuit 330 of FIG. 3 and FIG. 5 further includes a detection circuit 600. As shown in FIG. 6, the detection circuit 600 includes an analog-to-digital conversion circuit 610. The analog-to-digital conversion circuit 610 is configured to convert the control voltage VCTL into a digital code DC to monitor the resonant voltage VCR. According to some embodiments of the present invention, the control circuit 330 can know the voltage value of the control voltage VCTL via the digital code DC, and determine whether the resonant voltage VCR is sufficiently low based on the relationship between the control voltage VCTL and the demagnetization voltage DMG, so as to determine whether to drive the high-side transistor 111 and the low-side transistor 112.

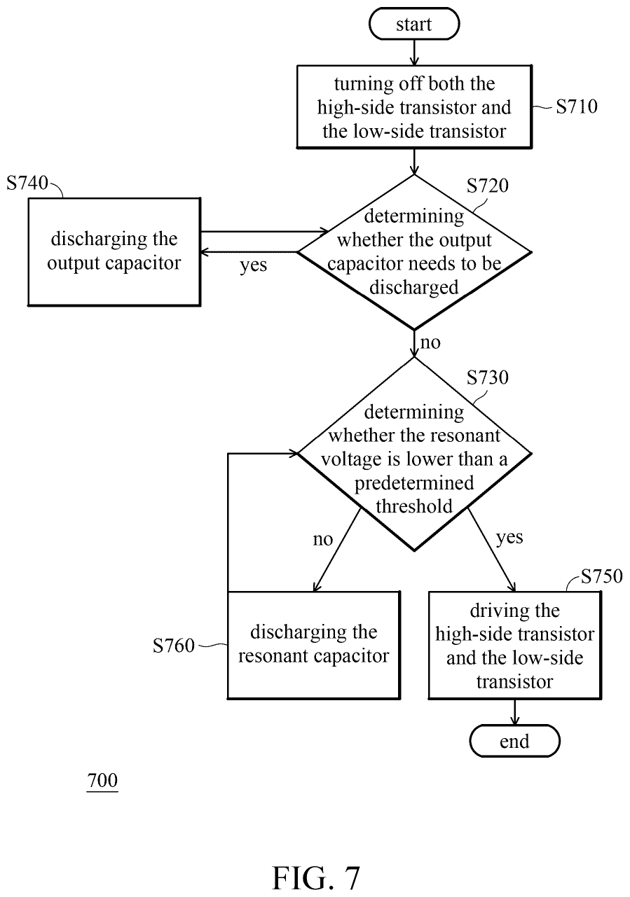

FIG. 7 is a flow chart of a control method for a power conversion circuit in accordance with an embodiment of the present invention. The following description of control method 700 in FIG. 7 will be combined with the power conversion circuit 300 in FIG. 3 for detailed explanation. As shown in FIG. 7, after the high-side transistor 111 and the low-side transistor 112 both are turned off (Step S710), it is determined whether the output capacitor COUT needs to be discharged (Step S720), and whether the resonant voltage VCR is lower than a predetermined threshold (Step S730).

According to some embodiments of the present invention, after high-side transistor 111 and low-side transistor 112 both are turned off, Step S720 and Step S730 may be performed simultaneously. It is illustrated in FIG. 7 that Step S720 is performed first and then Step S730 is performed, but the present invention is not intended to be limited thereto. When the determination in Step S720 is yes, the output capacitor COUT is discharged (Step S740), so as to reduce the output voltage VOUT.

According to an embodiment of the present invention, when it is determined in Step S720 that the output voltage VOUT is lower than the low voltage threshold, Step S740 is performed to discharge the output capacitor COUT, causing the power conversion circuit 300 to restart. According to another embodiment of the present invention, when it is determined in Step S720 that the output voltage VOUT exceeds the high voltage threshold, Step S740 is performed to discharge the output capacitor COUT.

According to an embodiment of the present invention, when the signal generation circuit 400 of FIG. 4 determines that the output voltage VOUT exceeds the first voltage threshold VT1 or does not exceed the second voltage threshold VT2 (i.e., the determination in Step S720 is yes), the discharge switch SWD of FIG. 3 is turned on, so that the output capacitor COUT is discharged through the output discharge resistor ROD (i.e., Step S740), thereby reducing the output voltage VOUT.

According to another embodiment of the present invention, when the signal generation circuit 400 of FIG. 4 determines that the output voltage VOUT exceeds the first voltage threshold VT1 or does not exceed the second voltage threshold VT2 (i.e., the determination in Step S720 is yes), the discharge switch SWD of FIG. 5 is turned on, so that the output capacitor COUT is discharged with the first current I1 (i.e., Step S740) to reduce the output voltage VOUT.

According to some embodiments of the present invention, the control circuit 330 knows the control voltage VCTL based on the digital code DC generated by the analog-to-digital conversion circuit 610 in FIG. 6, and determines whether the resonant voltage VCR is lower than a predetermined threshold, thereby determining whether the resonant capacitor CR needs to be discharged. When it is determined that the resonant voltage VCR is lower than the predetermined threshold (i.e., the determination in Step S730 is yes), the high-side transistor 111 and the low-side transistor 112 are driven (i.e., Step S750). When it is determined that the resonant voltage VCR is not lower than the predetermined threshold (i.e., the determination in Step S730 is no), the resonant capacitor CR is then discharged (i.e., Step S760).

According to another embodiment of the present invention, the control circuit 330 determines whether the resonant voltage VCR is lower than a threshold based on the relationship between the control voltage VCTL and the demagnetization voltage DMG (i.e., Step S730). When the product of d1, m, 1/n, and 1/d2 in Eq. 7 is equal to 1 and the control voltage VCTL is not lower than the demagnetization voltage DMG, the control circuit 330 determines that the resonant voltage VCR is not lower than the predetermined threshold (i.e., the determination in Step S730 is no), and the resonant capacitor CR needs to be discharged (i.e., Step S760).

When the control voltage VCTL is lower than the demagnetization voltage DMG (i.e., the determination in Step S730 is yes), the control circuit 330 determines that the resonant voltage VCR is lower than the predetermined threshold, and there is no need to discharge the resonant capacitor CR. After Step S730, the control circuit 330 then drives the high-side transistor 111 and the low-side transistor 112 (i.e., Step S750).

The present invention provides a power conversion circuit and a control method thereof, which determines whether to discharge the resonant capacitor and the output capacitor after the high-side transistor and the low-side transistor both are turned off, so as to avoid generating surges in the secondary coil of the transformer to reduce the life of components.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit for converting an input voltage to an output voltage, comprising:
a resonant capacitor, coupled between a resonant node and a ground, wherein a resonant voltage is generated at the resonant node;
a transformer, comprising a primary coil and a secondary coil, wherein the primary coil is coupled between a switch node and the resonant node;
a high-side transistor, providing the input voltage to the switch node based on a high-side driving signal;
a low-side transistor, coupling the switch node to the ground based on a low-side driving signal; and
a control circuit, generating the high-side driving signal and the low-side driving signal based on the output voltage and the resonant voltage;
wherein when the high-side transistor and the low-side transistor are both turned off, the control circuit first determines whether the resonant voltage is lower than a predetermined threshold, and then drives the high-side transistor and the low-side transistor.

2. The power conversion circuit as claimed in claim 1, wherein a discharge rate of the output voltage is faster than a discharge rate of the resonant capacitor.

3. The power conversion circuit as claimed in claim 1, further comprising:
a first discharge circuit, discharging the resonant capacitor; and
a second discharge circuit, discharging the output voltage.

4. The power conversion circuit as claimed in claim 3, wherein the first discharge circuit further comprises:
a detection resistor, coupled to the resonant node; and
a discharge resistor, coupled between the detection resistor and the ground;
wherein the control circuit adjusts the resistance value of the discharge resistor to adjust a discharge current for discharging the resonant capacitor.

5. The power conversion circuit as claimed in claim 4, wherein the resonant voltage is divided by the detection resistor and the discharge resistor to generate a control voltage;
wherein the control circuit further comprises:
an analog-to-digital converter, configured to convert the control voltage into a digital code;
wherein the control circuit determines whether the resonant voltage is lower than the predetermined threshold based on the digital code;
wherein when the control circuit determines that the resonant voltage is lower than the predetermined threshold, the control circuit generates the high-side driving signal and the low-side driving signal.

6. The power conversion circuit as claimed in claim 3, further comprising:
a rectification circuit, converting energy of the secondary coil into the output voltage based on a gate signal; and
a secondary control circuit, generating the gate signal;
wherein when the output voltage exceeds a first voltage threshold or does not exceed a second voltage threshold, the secondary control circuit enables a discharge signal.

7. The power conversion circuit as claimed in claim 6, wherein the secondary control circuit further comprises:
a first comparator, configured to compare the output voltage with the first voltage threshold to generate a first comparison signal;
a second comparator, configured to compare the second voltage threshold with the output voltage to generate a second comparison signal; and
an OR gate, performing a logic OR operation on the first comparison signal and the second comparison signal to generate the discharge signal.

8. The power conversion circuit as claimed in claim 7, wherein when the output voltage exceeds the first voltage threshold, the first comparator enables the first comparison signal;
wherein when the output voltage does not exceed the first voltage threshold, the first comparator disables the first comparison signal;
wherein when the output voltage does not exceed the second voltage threshold, the second comparator enables the second comparison signal;
wherein when the output voltage exceeds the second voltage threshold, the second comparator disables the second comparison signal;
wherein when the first comparison signal is enabled or the second comparison signal is enabled, the OR gate enables the discharge signal.

9. The power conversion circuit as claimed in claim 6, wherein the second discharge circuit comprises:
an output discharge resistor, coupled to the output voltage; and
a discharge switch, coupling the output discharge resistor to the ground based on the discharge signal being enabled, so that the output discharge resistor discharges the output voltage.

10. The power conversion circuit as claimed in claim 6, wherein the second discharge circuit comprises:
an output discharge current source, generating a first current and coupled to the output voltage; and
a discharge switch, coupling the output discharge current source to the ground based on the discharge signal being enabled, so that the output voltage is discharged with the first current.

11. The power conversion circuit as claimed in claim 6, further comprising:
an opto-coupler, generating a feedback voltage based on a feedback current;
wherein the secondary control circuit generates the feedback current based on the output voltage;
wherein the control circuit generates the high-side driving signal and the low-side driving signal based on the feedback voltage and the resonant voltage.

12. The power conversion circuit as claimed in claim 5, wherein the transformer further comprises:
an auxiliary coil, generating an auxiliary coil voltage;
wherein the power conversion circuit further comprises:
a first voltage divider circuit, multiplying the auxiliary coil voltage by a first voltage-dividing ratio to generate a demagnetization voltage;
wherein the control circuit generates the predetermined threshold based on the demagnetization voltage.

13. The power conversion circuit as claimed in claim 1, wherein the power conversion circuit is a resonant flyback power conversion circuit.

14. A control method for controlling a power conversion circuit to convert an input voltage to an output voltage, wherein the power conversion circuit comprises a resonant capacitor coupled between a resonant node and a ground, a transformer comprising a primary coil and a secondary coil, a high-side transistor providing the input voltage to a switching node, and a low-side transistor coupling the switch node to the ground, wherein the primary coil is coupled between the switch node and the resonant node, wherein the control method comprises the following steps:
simultaneously turning off the high-side transistor and the low-side transistor;
after the step of simultaneously turning off the high-side transistor and the low-side transistor, determining whether a resonant voltage at the resonant node is lower than a predetermined threshold; and
when it is determined that the resonant voltage is lower than the predetermined threshold, driving the high-side transistor and the low-side transistor to generate the output voltage.

15. The control method as claimed in claim 14, further comprising the following steps:
determining whether the output voltage needs to be discharged;
when it is determined that the output voltage needs to be discharged, discharging the output voltage; and
when it is determined that the output voltage does not need to be discharged, not discharging the output voltage.

16. The control method as claimed in claim 15, wherein the step of determining whether the output voltage needs to be discharged further comprises the following steps:
determining whether the output voltage exceeds a first voltage threshold or does not exceed a second voltage threshold;
when it is determined that the output voltage exceeds the first voltage threshold or does not exceed the second voltage threshold, discharging the output voltage; and
when it is determined that the output voltage does not exceed the first voltage threshold and exceeds the second voltage threshold, not discharging the output voltage.

17. The control method as claimed in claim 15, wherein the step of determining whether the output voltage needs to be discharged is performed simultaneously with the step of determining whether the resonant voltage at the resonant node is lower than the predetermined threshold.

18. The control method as claimed in claim 15, wherein the step of determining whether the output voltage needs to be discharged is performed after the step of simultaneously turning off the high-side transistor and the low-side transistor, and before the step of determining whether the resonant voltage at the resonant node is lower than the predetermined threshold.

19. The control method as claimed in claim 15, wherein the step of discharging the output voltage further comprises the following steps:
coupling an output discharge resistor to the output voltage, so that the output voltage is discharged through the output discharge resistor.

20. The control method as claimed in claim 15, wherein the step of discharging the output voltage further comprises the following steps:
sinking a first current from the output voltage, so that the output voltage is discharged with the first current.

21. The control method as claimed in claim 14, wherein a discharge rate of the output voltage is faster than a discharge rate of the resonant capacitor.
